(19) United States
(12) Patent Application Publication
(10) Pub. No.: US 2005/0217233 A1
(43) Pub. Date: Oct. 6, 2005

(54) Hydraulic bale ramp

(76) Inventors: Kevin M. Smith, Narvon, PA (US); Michael Fyock, Lititz, PA (US); Sean McIntoish, Newark, DE (US); Daniel Meckley, York, PA (US); John Unger, Lancaster, PA (US)

Correspondence Address: Haverstock Garrett & Roberts, Suite 1610, 611 Olive, St. Louis, MO, 63103, US

(21) Appl. No.: 10/816,993

(22) Filed: Apr. 1, 2004

(51) Int. Cl. A01D 39/00; A01D 43/02; A01D 75/00

(52) U.S. Cl. 56/341

(57) ABSTRACT

An improved round baler having a weight-balanced discharge ramp which pivots hydraulically from a dump position to a home position where it protects the baler's tailgate from damage.

### TECHNICAL FIELD

This invention relates generally to round balers, for converting loose crop stock or fodder into cylindrical bales. The invention particularly relates to ejection components, which discharge or eject the bales from the baler.

### BACKGROUND ART

Round balers for crop stock such as clover or alfalfa hay, have long been known in the art. These machines are employed after the crop stock is mowed and gathered into a windrow. Customarily, the balers are driven down the windrow, from which it intakes the crop fodder, forms a cylindrically configured bale in a bale-forming chamber, and then discharges the bale from the baler. The balers can be either self-propelled or pulled by, for example, a farm tractor.

Previously, round bales could be easily handled, manually. Such bales were two feet long cylindrical rolls, had a maximum diameter of less than about three feet, and weighed at most 100 lbs. Now, the bales have a length of about five feet, a maximum diameter of about five feet, can weigh 1500 lbs., and must be handled mechanically.

In operating round balers, farmers customarily discontinue intake of the fodder from the windrow while the baler finishes forming the bale, ties the bale with wire, plastic or twine, and discharges the bale from the rear of the baler to the ground. Additionally, it is usually necessary to back up the round baler, prior to discharging the bale, in order to avoid skipping portions of crop once intake recommences. The stopping, backing up, and restarting steps, along with the increasingly larger size of the baling machines, have generated growing concerns.

The larger round balers typically include a front and a rear portion (called the tailgate) which come together creating a bale formation chamber. A seven-step discharge sequence occurs after the farmer discontinues fodder intake. First, the operator stops the forward movement of the baler. Second he reverses directions, backing up a predetermined distance. Third, he opens the tailgate. Fourth, he discharges the bale. Fifth he moves forward. Sixth he closes the tailgate, and then Seventh he recommences baling. Failure to back-up, during the sequence, results in considerable unbaled crop stock being left on the ground. Tailgate damage can be caused by closing the tailgate before driving forward on hilly terrain. A bale ramp is desired which positively positions the bale far enough from the tailgate so backing up to eject the bale is not necessary.

Prior art attempts to avoid tailgate damage, during the discharge sequence, have led to the development of several different kinds of baler ejection components, none of which universally protect the tailgate from discharged bales. These ejection components are for example, ramps, conveyors, pushers, and kickers.

Typical of the ramp approach are U.S. Pat. No. 3,974,632 to Van der Lely, U.S. Pat. No. 4,559,770 to Mast, and U.S. Pat. No. 4,566,380 to Clostermeyer et al. The VanderLely patent discloses a ramp which, when deployed, extends rearwardly and groundwardly from the baler. The ramp, when not deployed, serves as lower portion of the rear wall of the baler. The Mast patent discloses a ramp that is pivotally connected to the baler frame. Similarly, Clostermeyer teaches a ramp attached to the rear of the baler. However, in each case, after discharging bales from the “ramps” on a downhill topography the bales roll back into the baler's tailgate.

Representative of conveyer-type ejection components is U.S. Pat. No. 4,683,815 to Van Ryswyk which teaches the attachment of a chain-driven conveyor-type system to the rear of the baler. Upon opening of the rear portion of the baler, the conveyor pivots downwardly in response to the weight of the bale such that its rearwardmost position contacts the ground. Although conveyors can work the bales further away from the baler than can ramps, the mechanism can be expensive and cumbersome.

Representative of the pusher-type components are U.S. Pat. No. 4,779,527 to Ardueser et al, and U.S. Pat. No. 4,483,247 to Coeffic. These patents teach the use of a U-shaped pusher mechanism, pivotally attached to the front section of the baler, and used to push a discharged bale away from the baler, after discharge, and to retain the bale in such a position while the rear gate of the baler closes.

Representative bale kickers are found in U.S. Pat. No. 4,458,587 to Jennings, U.S. Pat. No. 4,406,221 to Parrish et al, and U.S. Pat. No. 4,206,587 to Freimuth et al. Each of the three referenced patents teaches a bale kicker comprised of a U-shaped structure attached to the rear portion of the baler. The U-shaped structure is spring biased so that, as a discharged bale rolls over the crossbar portion of the “U”, a coil spring is stretched thereby allowing the U-shaped kicker to pivot towards the ground. As the center of gravity of the bale passes over the bar rearwardly of the baler, the spring begins to retract, pivoting the U-shaped member upwardly and providing additional impetus to the bale as it is discharged from the baler. This additional rearward impetus is referred to as a kick and results in the bale being discharged slightly further rearwardly from the baler.

The above-described prior art ejection components, as previously stated, do not completely solve the problems of bale discharge. While basically a simple device, the kicker mechanisms require springs of great strength in order to provide a rolling impetus to a bale which may weigh as much as 1500 lbs., and even then may fail to move the bale far enough away from the baler. In addition, as the kicker returns to its position, it does so with a force directly proportional to the spring constant of the springs used. This can result in loud clanging noises as the kicker returns to its position as well as in jarring motions and structural damage to the baler. Although the ramps offer a simpler solution, they can fail to produce the desired results when baling is carried out on terrain that is not flat. The complexity of the conveyor and the pusher present additional mechanical breakdown problems. For example, conveyors rely upon chain-driven conveyance systems to move a bale away from the tailgate. The pushers utilize shock absorbing systems to work against the energy of the spring assembly which further complicates maintenance and repair.

Recently, U.S. Pat. No. 4,821,637 to Viaud discloses a support or ramp for a completed bale which is maintained in horizontal position by an abutment bar on the discharge gate during the time that the gate is closed, but is released when the gate opens. This avoids using energy from the bale for swinging the ramp down, but relies on the bale rolling away from the gate. It does not work well on downhill terrain.

U.S. Pat. No. 5,263,410 to Olin teaches use of a valve and hydraulic circuit for interconnecting a baler's discharge gate and bumper or kicker, but its kicker is excessively heavy and its kicking/returning components are undesirably complex.

U.S. Pat. No. 5,822,967 to Hood et al. discloses a cradle pivotably supported by an arm structure, which cradle holds an ejected bale, then pivots rearwardly and downward to dump the ejected bale. This system also relies on the bale rolling away from the tailgate in order not to obstruct the tailgate's closure.

U.S. Pat. No. 6,240,712 to Meijer discloses a non-return element for preventing roll back of bales and a tilt control element for tilting the baler's rear end between an upper position for collecting the bale and a lower position for unloading the bale. This non-return element is spring biased to also allow kicking away the bale. However, finding the optimum spring coefficient is problematic as is the overall weight of the device.

U.S. Pat. No. 6,272,825 to Anderson et al, discloses a clutch for drivingly disconnecting a bale-forming mechanism, from the driveline while the tailgate is raised to discharge a wrapped bale. Engagement and disengagement of the clutch is controlled by a piston and cylinder assembly. Distancing a discharged bale away from the discharge gate on downhill terrain is problematic.

### SUMMARY OF THE INVENTION

Thus a need has evolved for a bale discharge apparatus which performs several desirable functions. Principally, such an apparatus should deposit a bale on the ground, at a desired position rearward of where it would be if it simply fell from the rear of the baler. Also, it should retain the discharged bale at the desired discharge position while the tailgate of the baler closes, thereby preventing the tailgate from coming into contact with a discharged bale. Furthermore, it would be a welcomed advancement for the apparatus to retain a discharged bale at the desired position, in such a way that allows the operator to stop the baler, discharge a bale therefrom, and then continue onward with no back up maneuvering necessary, and without leaving any unbaled crop in the field. Finally, it is highly desired that such an apparatus be mechanically simple and impart minimal reaction forces to the baler during or after bale discharge.

The present invention provides a baler with a bale ramp having the ability of positively placing a bale at a position rearward of a round baler, so that the bale will not interfere with the closing of the tailgate. The bale ramp consists of a pivoting ramp member attached to the distal end of a cantilever support which cantilever is attached at its proximate end to the axle of the baler or other appropriate support element on the baler, and the ramp is actuated by a hydraulic cylinder which pivots or tilts the ramp. The tilting ramp member has two positions, i.e. “home”, and “dump.”

When the bale has been wrapped, it is ready to be ejected from the baler. At that point, the tailgate is rotated to a substantially, but not completely, open position by hydraulic piston and cylinder action, and the bale rolls out of the baling chamber and onto the bale ramp. The bale ramp is then hydraulically tilted at a pivot point to its “dump” position causing the bale to roll down the ramp to a distance from the baler. Then the tailgate continues to rise while the bale ramp moves to its “home” position. The tailgate may then begin rotation back to its closed position, during which time the ramp, in its home position, holds the bale far enough away from the baler to allow the tailgate close without interference.

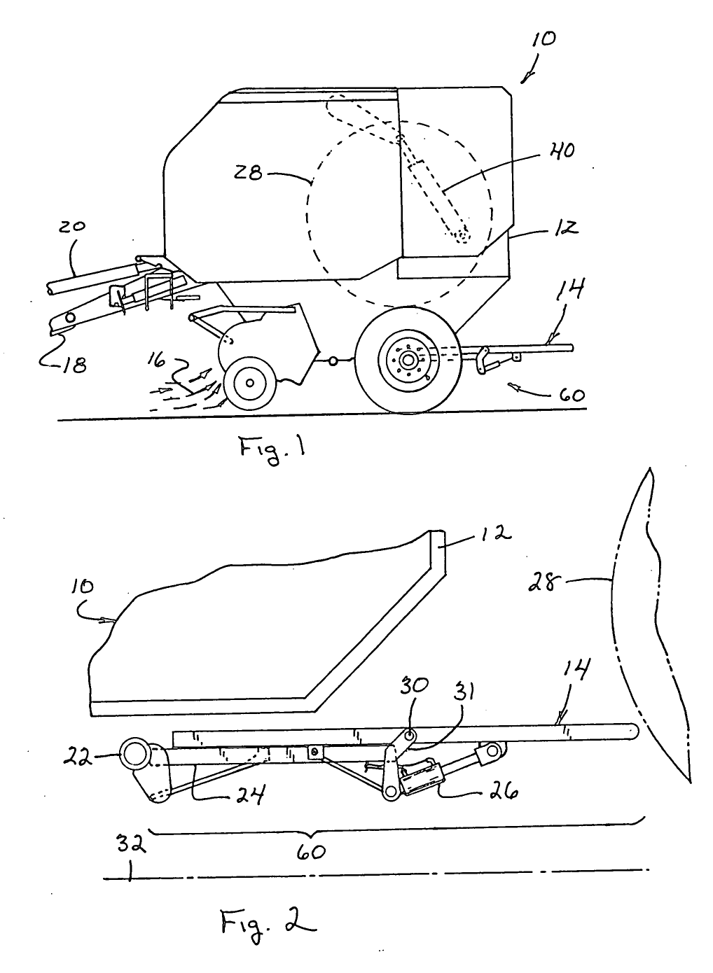

FIG. 1 is a side elevational view of the baler and bale ramp of this invention.

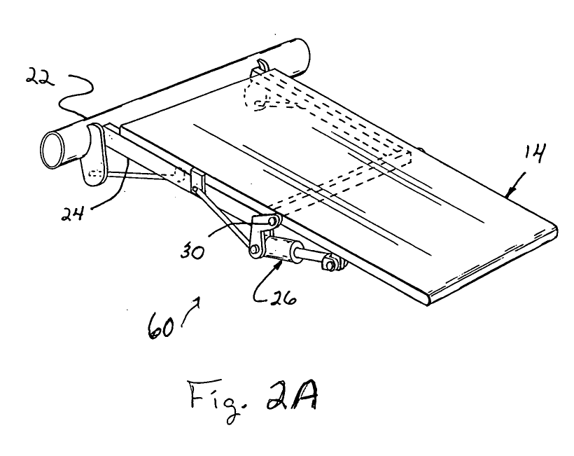

FIG. 2 is a partial side elevational view of the baler tailgate with a hydraulic bale ramp in home position.

FIG. 2A is a perspective view of the ejection element of the present invention.

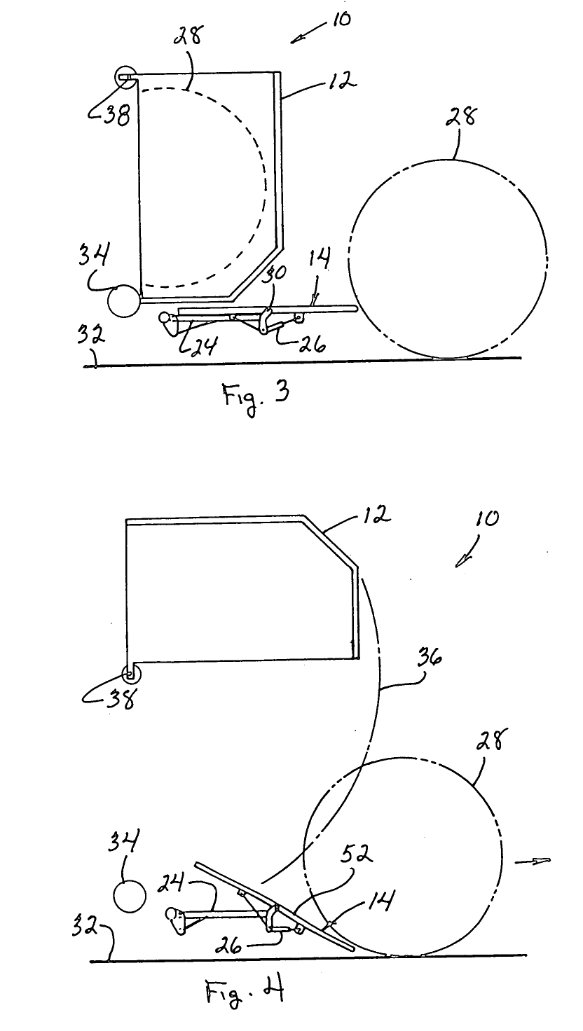

FIG. 3 is a partial side elevational view of the baler tailgate and ramp with a bale inside the chamber and a bale after discharge from the ramp and after the ramp returns to home position.

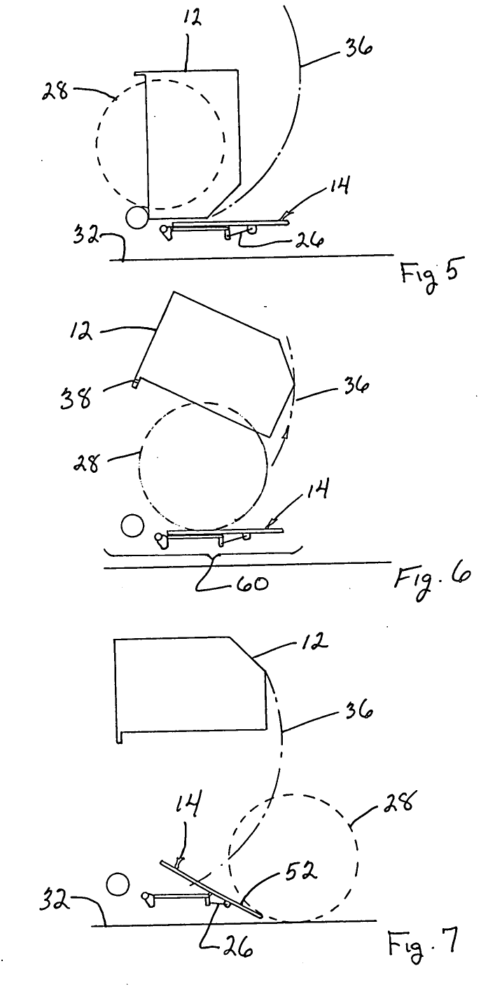

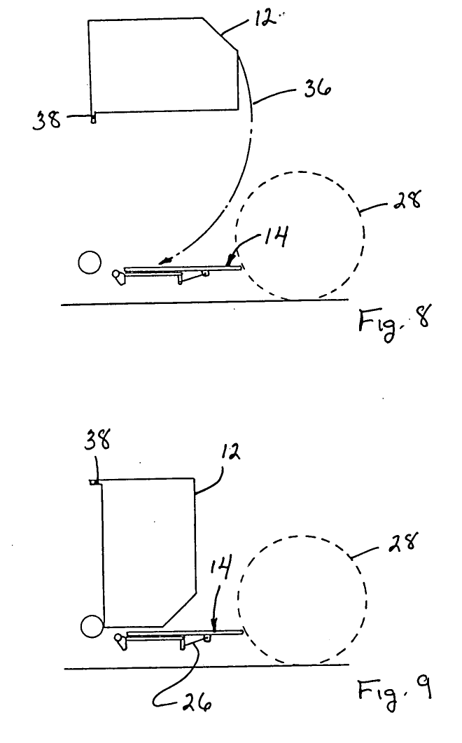

FIG. 4 is a partial side elevational view of the baler tailgate open and with bale ramp in the dump position.

FIG. 5 is a partial side elevational view of baler tailgate closed, prior to the discharge sequence's first position.

FIG. 6 is a partial side elevational view of baler with tailgate beginning to open and discharging bale onto the bale ramp.

FIG. 7 is a partial side elevational view with tailgate continuing to open and bale ramp dump position while allowing bale to roll onto ground.

FIG. 8 is a partial side elevational view with tailgate moving to full open position while the ramp returns to home position.

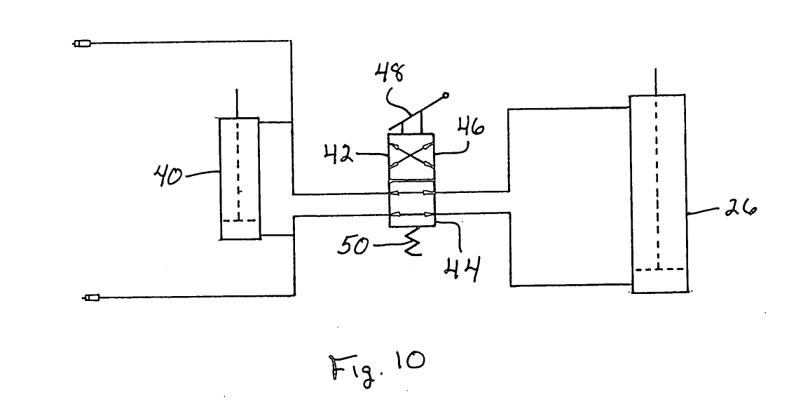

FIG. 9 is a partial side elevational view with the tailgate having closed, the ramp having returned to home position and the ramp having prevented the bale from rolling back into the tailgate.

FIG. 10 is a schematic drawing of a hydraulic flow diagram of the tailgate and bale ramp common pressurized fluid two-way valve sequence.

### DETAILED DESCRIPTION OF THE INVENTION

Referring to the drawings in detail, FIG. 1 shows the apparatus of the present invention. A baler 10, commonly known as a round baler, which is towed behind, for example, a tractor (not shown) by way of hitch 18, is powered by the power take off shaft 20. Fodder 16 is fed into the baler 10 and the fodder 16 is formed into a cylindrical bale 28, as by rolling action. The baler 10 also wraps the bale 28 with, for example, plastic, foil, or if possible wire wrapping material (not shown).

After bale 28 has been formed to a predetermined size, the baling mechanism of baler 10 is stopped, and the tailgate 12 is actuated by piston cylinder 40, to begin opening up by rotation about a pivot point 38 (shown in FIG. 3). Consequently, bale 28 is discharged out of baler 10, and onto the bale ramp 14 (FIG. 6) component of ejection element 60 (FIG. 2A). Bale ramp 14 is rotatably attached to bracket 31 at pivot point 30 by pinion, hinge, or other rotatable means. Bracket 31 is fastened to a nonmoving cantilever support 24 which can be in the form of a frame, or a rack, or a single support arm, or multiple support arms. The cantilever support 24 extends rearward from its connection to the axle 22, or other baler rear support member. After bale 28 is discharged onto ramp 14, tailgate 12 continues to open up toward its fully open position (FIG. 7) along arc 36 via operation of piston cylinder 40 (shown in FIGS. 1 and 10). Simultaneously, hydraulic piston cylinder 26 is actuated and rotates bale ramp 14 about axis 30 to its dump position (FIGS. 4 and 7) and bale 28 rolls down surface 52, onto surface 32 (ground). Tailgate 12 continues to further open its fully open position, as bale ramp 14, by operation of cylinder 26, returns to the bale ramp home position (see FIG. 8). Tailgate 12 stops rising and returns to its original closed position (FIG. 9) which ramp 14 prevents bale 28 from interfering with it. Even if baler 10 is on a downhill slope, bale 28 will not roll back into the gate 12; thus, there is no interference with the tailgate closing, and no tailgate damage from previously discharged bales.

The ejection sequence explained above can be accomplished with two hydraulic valves in a controlled circuit using a common pressurized fluid, or can be accomplished with one valve. Preferably, a single two-position valve 42 with spring return 50 is installed in parallel with tailgate cylinder 40 and bale ramp cylinder 26. Valve 42 can be controlled either with a mechanical linkage attached to the tailgate or electrically with position sensors and solenoids (not shown).

The hydraulic circuit functions as illustrated in FIG. 10. When tailgate 12 rises, by rotating about pivot point 38, and bale 28 begins to drop onto bale ramp 14, valve 42 is in the “home” position 44, which corresponds to ramp 14 being in the “home” position. This circuit maintains pressure on the base end of ramp cylinder 26, which keeps bale ramp 14 in the home position. At a predetermined tailgate position along arc 36, valve 42 is shifted from the “home” position 44 to “dump” position 46. This redirects the hydraulic oil to the rod end of ramp cylinder 26, moving the ramp to its “dump” position. Preferably, the ramp cylinder 26 is sized to accommodate a lower pressure for operating the ramp than is required to lift the tailgate. With the ramp in its “dump” position, tailgate opening resumes and valve 42 remains in position 46. At another predetermined position for tailgate 12, valve 42 is released by spring 50 and returns to home position 44, redirecting hydraulic fluid to the base end of ramp cylinder 26 and bale ramp 14 returns to its home position. Tailgate 12 motion resumes, lowering the tailgate to its closed position and baling of fodder 16 may resume.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

1. An improved round baler of the type having a hydraulic tailgate for releasing a cylindrical bale onto an ejection element, said tailgate and said ejection element each being hydraulically operable by separate piston and cylinder units which are sequentially controlled in parallel by a common pressurized fluid source via a two-way valve sequence; the improvement comprising:
an ejection element pivotally connected to a nonmoving cantilever support extending rearward from the rear axle or support element of the baler, and therefrom extending rearwardly to its distal end, said ejection element being pivotable between a dump position and a home position where the ejection element protects the balers tailgate from damage, and said element having a length long enough to hold a dumped bale sufficiently distant from the baler to allow the tailgate to close, while short enough to negate the need to be collapsible or to otherwise require additional adjustment.

2. The baler of claim 1 wherein the ejection element consists essentially of a ramp member affixed to a cantilever support, which support is connected to the axle.

3. The baler of claim 2 wherein the ramp member, in the home position, is positioned to receive a discharged bale prior to pivoting to the dump position.
